(19) United States
(12) Patent Application Publication
(10) Pub. No.: US 2022/0058564 A1
(43) Pub. Date: Feb. 24, 2022

(54) PERSON-IN-CHARGE RECOMMENDATION SYSTEM BASED ON TASK TRACKER

(71) Applicant: PNPSOFT Co., Ltd., Suwon-si (KR)

(72) Inventors: Dae Han LEE, Suwon-si (KR); Kyung Lim KANG, Suwon-si (KR)

(73) Assignee: PNPSOFT CO., LTD., Suwon-si (KR)

(21) Appl. No.: 17/518,220

(22) Filed: Nov. 3, 2021

Related U.S. Application Data
(63) Continuation of application No. PCT/KR2020/003976, filed on Mar. 24, 2020.

(30) Foreign Application Priority Data
May 10, 2019 (KR) 10-2019-0054934

(51) Int. Cl. G06Q 10/06

(52) U.S. Cl. CPC G06Q 10/063112; G06Q 10/06398; G06Q 10/063114

(57) ABSTRACT

The present invention is to solve a problem of a previously described prior art, in which, in a task management system, when a task for a process is generated, an optimal person-in-charge can be recommended in consideration of a processing time and a level of task satisfaction via a task tracker. In this case, an OV value may be used, wherein, in regard to the OV value, a weight value for an OV value desired by a user who creates a task may be configured, and the weight value may be configured for the processing time and the task satisfaction.

### CROSS-REFERENCE TO RELATED APPLICATIONS

This application is a continuation of International Application No. PCT/KR2020/003976 filed on Mar. 24, 2020 which claims priority to Korean Patent Application No. 10-2019-0054934 filed on May 10, 2019, the entire contents of which are herein incorporated by reference.

### TECHNICAL FIELD

The present invention relates to a person-in-charge recommendation system based on a task tracker, and more particularly, to a person-in-charge recommendation system in which, in a case in which a process task is created, a task management system recommends a person in charge optimized for a process based on information of a task tracker.

### BACKGROUND

As a size of a company is increased and there are various tasks and the tasks are becoming more complex according to development of new technologies, a task management system for efficient task management is being actively developed.

In a task management system of the related art, content of a task is notified to a person in charge, or a manager who instructs the task directly assigns the person in charge, and the person in charge or the manager directly sets priorities for the task and manages a schedule, and thus, there is a problem in that it is difficult to perform an efficient management.

In addition, the manager does not know characteristics of each person in charge, such as task processing time or a satisfaction level for the task processing, and thus, it is difficult to determine a person in charge.

### SUMMARY OF INVENTION

### Technical Problem

The present invention is to solve the problems of the related art described above, and when creating a task for a process, a task management system may recommend an optimal person in charge by considering processing time and a task satisfaction level through a task tracker.

In this case, an OV value may be used, and a user who creates a task may set a weight value for a desired OV value, and the weight value may be set for processing time and a task satisfaction level.

### Solution to Problem

As technical means for solving the technical problems described above, a person-in-charge recommendation system based on a task tracker which is performed by a server, includes (a) a step of receiving an input for generating a process task including information about a task to be requested from a user terminal owned by a task client; (b) a step of activating the task tracker corresponding to the process and receiving an input for the task tracker from the user terminal; (c) a step of providing a user interface for OV (optimal value) weight value input; (d) a step of providing a plurality of pieces of person-in-charge information to perform the process task, based on the OV weight value; (e) a step of receiving a selected input for any one of the plurality of pieces of person-in-charge information; and (f) a step of generating the process task such that a selected person in charge is included in the process task.

In addition, the person-in-charge recommendation system may further include a step of storing data on a task name, classification, task content, and a processing period and a task satisfaction level for each person in charge for a previously performed task.

The processing period may be an average value of a period taken for a specific task for each person in charge, and the task satisfaction level may be an evaluation score received from a user terminal requesting the process generation for each person in charge.

The person-in-charge recommendation system may further include a step of receiving an input for a task name, classification, and task content for the process generation, and the user interface may receive weight value ratios for a task processing period and a task satisfaction level, perform adjustment within a numerical value in which a sum of the ratios for the task processing period and the task satisfaction level is 100, and apply a ratio value of “50” in a case of not receiving ratio values for the task processing period and the task satisfaction level from the user terminal

In addition, a selected input for any one department among a plurality of preset department lists may be received, and the plurality of pieces of person-in-charge information may be provided in a form of a two-dimensional graph.

The two-dimensional graph may be a graph in which one axis is defined as a task processing period and the other axis is defined as a task satisfaction level.

The step (d) may include a step of calculating an annual average value of processing periods and task satisfaction levels of all tasks previously completed, and calculating an average value of processing periods and task satisfaction levels according to a type of task for recent one month of the plurality of persons in charge, and a step of calculating an OV value that is a deviation of a processing period and a task satisfaction level according to a type of task for each person in charge, wherein the shorter the processing period and the higher the task satisfaction level, the higher the OV value.

In this case, the OV value may be calculated as a numerical value having a value of 0 to 100 according to a deviation of an average value by setting the average value as 50, for each type of task and for each person in charge.

In a case in which a selected input for any one department is received, information on all other users belonging to the department may be provided as the person-in-charge information, and, in a case in which the selected input for the department is not received, information on a corresponding user among other pieces of user information previously stored may be provided as the person-in-charge information, based on the OV weight value.

Information on a person in charge with a highest matching rate based on the OV weight value among the plurality of persons in charge may be provided in a color different from colors of other persons in charge, and in a case in which a plurality of persons in charge are required for the process, the step (c) to the step (e) may be repeated as many as the required number of persons in charge.

In addition, a server that operates a person-in-charge recommendation system based on a task tracker, may include a memory storing a program a person-in-charge recommendation program based on the task tracker; and a processor executing the program.

The processor may execute the program to receive an input for process generation from a user terminal, activate the task tracker corresponding to the process and receive an input for the task tracker from the user terminal, provides a user interface for OV (optimal value) weight value input, provide a plurality of pieces of person-in-charge information based on the OV weight value, and receive a selected input for any one of the plurality of pieces of person-in-charge information.

### ADVANTAGEOUS EFFECTS

According to the present invention, when a manager instructing a task sets a weight for processing time and a task satisfaction level according to characteristics of a corresponding task, a task tracker recommends a suitable person in charge to perform efficient task management.

In addition, with respect to task processing time, an average of processing periods of the previous corresponding task for each person in charge may be calculated, and a deviation may be provided by comparing an expected processing period of the person in charge recommended by the system with a processing period of an actual person in charge.

### BRIEF DESCRIPTION OF THE DRAWINGS

FIG. 1 is an example diagram for a person-in-charge recommendation system based on a task tracker, according to an embodiment of the present invention,

FIG, 2 is an example diagram for a user interface of the person-in-charge recommendation system based on the task tracker, according to the embodiment of the present invention,

FIG. 3 is an example diagram for a two-dimensional graph for recommending the person-in-charge recommendation system based on the task tracker, according to the embodiment of the present invention.

FIG. 4 is a flowchart illustrating the person-in-charge recommendation system based on the task tracker, according to the embodiment of the present invention.

FIG. 5 is a flowchart illustrating a method of calculating an OV value of the person-in-charge recommendation system based on the task tracker, according to an embodiment of the present invention.

### DETAILED DESCRIPTION

Hereinafter, embodiments of the present invention will be described in detail with reference to the accompanying drawings such that those skilled in the technical field to which the present invention belongs may easily implement the present invention. However, the present invention may be embodied in several different forms and is not limited to the embodiments described herein. In addition, in order to clearly describe the present invention in the drawings, parts irrelevant to the description are omitted, and similar reference numerals are attached to similar parts throughout the specification.

Throughout the specification, when a portion is “connected” to another portion, this includes not only a case of being “directly connected” but also a case of being “electrically connected” with another element interposed therebetween. In addition, when a portion “includes” a certain component, this means that other components may be further included therein, rather than excluding other components, unless otherwise stated.

In the present specification, a “portion” includes a unit implemented by hardware, a unit implemented by software, and a unit implemented by using both. In addition, one unit may be implemented by using two or more pieces of hardware, and two or more units may be implemented by one piece of hardware. Meanwhile, “˜portion” is not limited to software or hardware, and “˜portion” may also be configured to be in an addressable storage medium or may also be configured to reproduce one or more processors. Thus, in one example, “˜portion” includes components such as software components, object-oriented software components, class components, and task components and includes processes, functions, properties, procedures, subroutines, segments of a program code, drivers, firmware, a microcode, a circuit, data, a database, data structures, tables, arrays, and variables. The functions provided in components and “˜portions” may be combined into a smaller number of components and “˜portions” or may be further separated into additional components and “˜portions”. In addition, components and “˜portions” may also be implemented to play one or more CPUs in a device or a secure multimedia card.

A “user terminal” referred to below may be implemented as a computer or portable terminal that may access a server or another terminal through a network. Here, the computer may include, for example, a notebook computer equipped with a web browser, a desktop computer, a laptop computer, a virtual reality (VR) head mounted display (HMD) (for example, HTC Vive, Oculus Rift, GearVR, DayDream, PSVR, and so on), and so on. Here, the VR HMD includes all standalone models (for example, Deepon, PICO, and so on) and so on implemented independently of a VR HMD for a personal computer (PC) (for example. HTC Vive, Oculus Rift, Fove, Deepon, etc.), a VR HMD for mobile (for example, GearVR, DayDream, Storm Horse, Google Cardboard, and so on), and a VR HMD for console (PSVR). A portable terminal is, for example, a wireless communication device that guarantees portability and mobility and includes not only a smartphone, a tablet PC, a wearable device, but also various devices equipped with communication modules such as Bluetooth (Bluetooth low energy (BLE)), near field communication (NFC), radio frequency identification (RFID), Ultrasonic, Infrared, Wi-Fi, LiFi, and so on. In addition, a “network” refers to a connection structure capable of exchanging information between respective nodes such as terminals and servers, and includes a local area network (LAN), a wide area network (WAN), the Internet (WNW: world wide web), wired and wireless data communication networks, a telephone network, wired and wireless television networks, and so on. Wireless data communication networks include, for example, 3rd generation (3G), 4G, 5G, 3rd generation partnership project (3GPP), long term evolution (LTE), world interoperability for microwave access (WIMAX), Bluetooth communication, infrared communication, ultrasound communication, visible light communication (VLC), LiFi, and so on, but are not limited thereto.

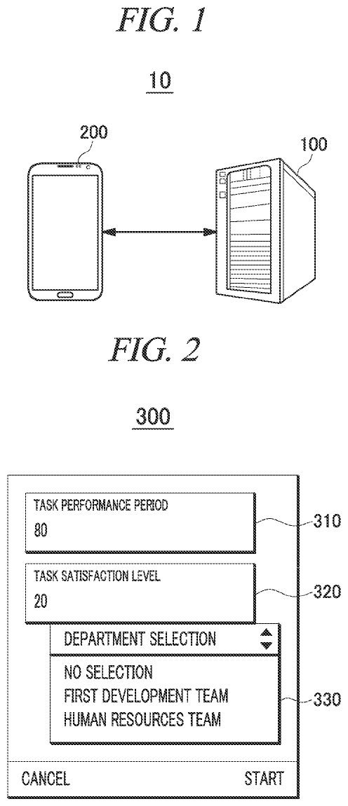

Hereinafter, a person-in-charge recommendation system based on a task tracker, according to an embodiment of the present invention will be described in detail with reference to FIG. 1.

According to an embodiment of the present invention, a person-in-charge recommendation system 10 based on a task tracker may be communicatively connected to a user terminal 200 through a wired/wireless network.

According to an embodiment of the present invention, a server 100 for operating the person-in-charge recommendation system 10 based on the task tracker includes a memory in which a person-in-charge recommendation program based on the task tracker is stored, and a processor that executes the program, and the processor may execute the program to receive an input for process generation from the user terminal 200, activate the task tracker corresponding to the process, receive an input for the task tracker from the user terminal 200, provide a plurality of pieces of contact information based on the OV weight value, and receive a selected input for any one of a plurality of pieces of person-in-charge information,

The user terminal 200 may be a real or virtual computing device corresponding to an environment in which the person-in-charge recommendation system 10 based on a task tracker is to be operated. In this case, the user terminal 200 may vary depending on an execution environment of the person-in-charge recommendation system 10 based on the task tracker.

For example, the user terminal 200 may be a smartphone or a tablet PC. Alternatively, the user terminal 200 may be a virtual smartphone or a virtual tablet PC operated by a computer device but is not limited thereto.

The user terminal 200 may have the person-in-charge recommendation system 10 based on the task tracker embedded therein and may be provided with the person-in-charge recommendation system 10 based on the task tracker from the server 100.

According to an embodiment of the present invention, the server 100 may provide a program for business management to the user terminal 200.

Hereinafter, the person-in-charge recommendation system based on the task tracker, according to an embodiment of the present invention will be described in detail with reference to FIG. 2.

According to an embodiment of the present invention, the server 100 may receive, from the user terminal 200, information on process steps obtained by dividing a process task in an order to be processed.

Here, the process steps indicate steps from a first-step task to a task step at which a process is terminated.

When a new task is created and process information is mapped, the task may be created as the first-step task of the process steps.

When the first-step task described above is created, the server 100 may activate a task tracker and may receive an input for activating the task tracker from the user terminal 200.

In addition, a user of the user terminal 200 that creates the first-step task may be any one of an in-house manager, an orderer, and a person in charge of an ordering company, and the person in charge who performs the first-step task may be another in-house employee, a contractor, a contracting company, but this is only an example for describing an embodiment of the present invention, and the present invention is not limited thereto, and the user may also be a company rather than an individual depending on the situation and may be applied differently.

Thereafter, when the task tracker is activated, the server 100 may provide a user interface 300 illustrated in FIG. 2 to the user terminal 200.

That is, the server 100 may store and search a list of a person in charge who will be in charge of all the tasks of the process steps and may store data on a processing period/task satisfaction level of a previously completed task for each person in charge and for each process step.

All tasks of the process steps may have standby, progress, and completion state, and when a new task occurs and process information is matched, whether the task is in standby or in progress is checked, and in a case in which the task is in a standby state, the user interface 300 for the task tracker in relation to the related task may be provided to the user terminal 200.

The task tracker may search for the person-in-charge information previously stored in the server 100, calculate an optimum value (OV) of a person in charge for each step for each task, and compare and analyze the value.

The OV may be divided into a task processing period and a task satisfaction level of the person in charge. The task processing period and the task satisfaction level may be calculated as an average value of a processing period and a task satisfaction level according to a task type for the recent one month for all tasks previously completed for each person in charge. The task satisfaction level may be evaluation information that may be received from other users after the person in charge completes the corresponding step for a previously completed task.

In this case, the task satisfaction level is evaluation information on task processing content such as “like” and may be information that may be received from other users except for the person in charge. It is possible to provide evaluation information of a preset number of times during a preset period for each user.

The task tracker may calculate deviation of the processing period and the task satisfaction level according to the task type for each person in charge in order to recommend a plurality of persons in charge and may calculate a higher OV value as the processing period for each task is shorter and the task satisfaction level is higher, and a weight value of the initially set processing period and the task satisfaction level may be 50:50.

In this case, the user terminal 200 may adjust a weight value for calculating the OV value through a processing time setting tab 310 and a task satisfaction level setting tab 320 of the user interface 300.

In a case in which there is a task that needs to be urgently processed, a person in charge with a quick task processing time has to be selected, and thus, the number of the processing time setting tab 310 may be increased such that a person in charge with a quick task processing time may be recommended. In a case in which quality of the task is more important than the task processing time, the number of the task satisfaction level setting tab 320 may be increased such that a person in charge with high task quality may be recommended.

A weight value of a default OV value is set to 50:50, but the most suitable person in charge may be recommended by changing the weight value according to the type and characteristics of a task created by a task manager, that is, the owner of the user terminal 200.

That is, a weight value may be input to create a process task and receive a recommendation for a person in charge who performs a task, and in this case, when a focus is on shortening a time to perform the corresponding task, a value of the task performance period may be set to be high. In contrast to this, when a focus is on a satisfaction level of a user and other performers who affect the task, a value of a task satisfaction level may be set to be high, and the sum of the two numbers may be set to 100.

Thereafter, in a case in which an input for a specific department is received from the user terminal 200 through a department selection tab 330, a person in charge in the corresponding department may be recommended, and in a case in which the input for the specific department is not received, a person in charge suitable for the corresponding task may be searched for from the list of all persons in charge stored in the server 100, and recommendation thereof may be made.

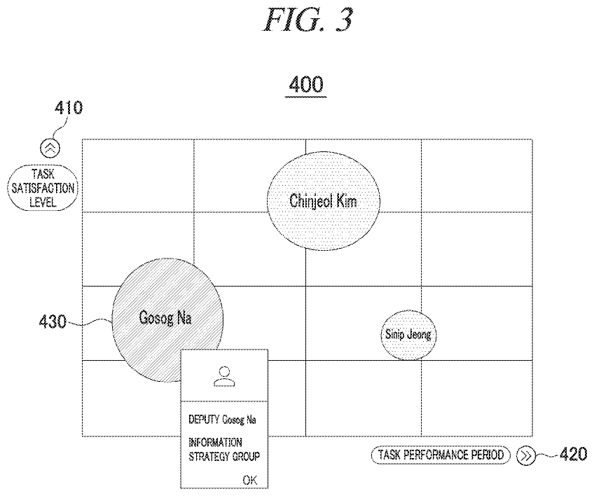

Hereinafter, a result of recommendation of a person in charge of the person-in-charge recommendation system based on the task tracker according to the embodiment of the present invention will be described in detail with reference to FIG. 3.

As illustrated in FIG. 3, the server 100 may provide the user terminal 200 with a person-in-charge recommendation graph 400 that composes a result screen in the form of a two-dimensional graph with information on a person in charge recommended through the task tracker.

As illustrated in FIG. 3, an X axis may be composed of processing time and a Y axis may be composed of a task satisfaction level, and a representative recommendation graph 400 in which each person in charge is located at a corresponding coordinate value may be provided.

The person-in-charge recommendation graph 400 displays the most suitable person in charge in a color different from colors of other persons in charge displayed on the person-in-charge recommendation graph 400, based on an OV weight value received from the user terminal 200, thereby highlighting a recommended person in charge 430.

In addition, in the person-in-charge recommendation graph 400, a name of each person in charge may be displayed at a position with a corresponding coordinate value, and when a mouse cursor is placed on the name of the person in charge or when a user input such as touch input is received, detailed information on the corresponding person in charge may be provided in the form of a window.

After the detailed information on the person in charge is provided in the form of a window, in a case in which a person in charge is designated in the corresponding window, selection of the person in charge may be finally completed, and the person in charge may be assigned in a specific task step.

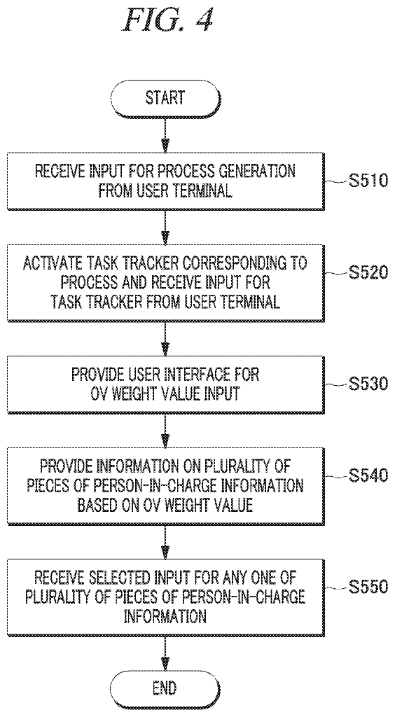

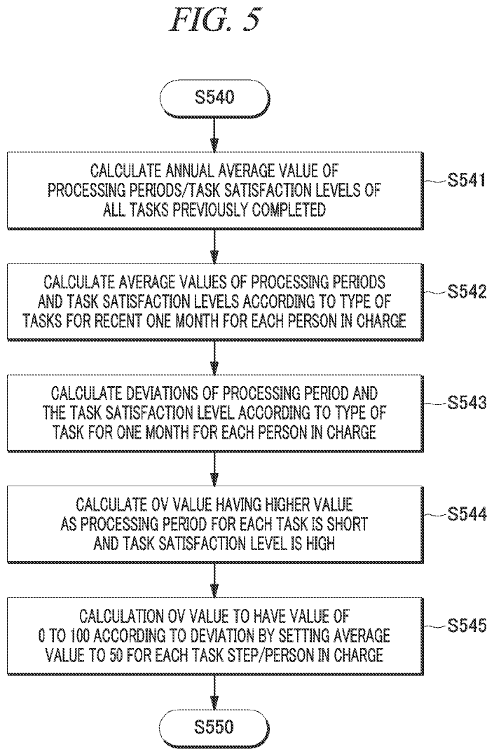

Hereinafter, the person-in-charge recommendation system based on the task tracker according to the embodiment of the present invention will be described in detail with reference to FIGS. 4 to 5.

The server 100 may store data on a task name, classification, task content, and a processing period and a task satisfaction level for each person in charge for the previously performed task and may compare and analyze the collected data.

In this case, the processing period may be an average value of periods taken for a specific task for each person in charge, and the task satisfaction level may be an evaluation score received from a terminal owned by another user except for the person in charge.

The server 100 according to an embodiment of the present invention may receive an input for process generation from the user terminal 200 and may receive an input for a task name, classification, and task content for the process generation (S510).

The server 100 may activate a task tracker corresponding to a process after receiving the input for the process generation from the user terminal 200 and receive an input for the task tracker from the user terminal 200 (S520).

That is, the person-in-charge recommendation system 10 based on the task tracker may receive a user input for creating a new task provided to the user terminal 200, and the new task created at this time will become a process task of a routine type.

When receiving a user input for generating a process task, the server 100 may create a detailed content field for selecting or input classification, content, and so on for the task and provide the detailed content field to the user terminal 200 and receive content input from the user terminal 200.

When an input for the detailed content field is received from the user terminal 200, a process task is newly created, and a first-step task for a corresponding task may be created.

In this case, the task tracker may be activated, and even after that, the task tracker may be activated at the time when task for each step is created.

When the task tracker is activated by an input of the user terminal 200, the server 100 may provide the user interface 300 for an OV weight value input to the user terminal 20 (S530).

At this time, the user interface 300 may receive weight value ratios for a task processing period and a task satisfaction level, perform adjustment within a numerical value in which the sum of the ratios for the task processing period and the task satisfaction level is 100, and apply a ratio value of “50” in a case of not receiving the ratio values for the task processing period and the task satisfaction level from the user terminal 206.

In addition, a selected input for any one department among a plurality of preset department lists may be received.

In a case in which the selected input for any one department is received, information on all other users belonging to the department may be provided as person-in-charge information, and in a case in which the selected input for the department is not received, information on a corresponding user among the previously stored information on other users may be provided as the person-in-charge information based on the OV weight value.

Thereafter, the server 100 may provide a plurality of pieces of person-in-charge information based on the OV weight value received from the user terminal 200 (S540).

A plurality of pieces of person-in-charge information may be provided in the form of a two-dimensional graph, and the two-dimensional graph may be a graph in which one axis is defined as a task processing period and the other axis is defined as a task satisfaction level. In this case, information on the person in charge with the highest matching rate based on the OV weight value among a plurality of persons in charge may be displayed in a color different from the colors of other persons.

Hereinafter, a method of calculating an OV value of a step S540 of providing a plurality of pieces of person-in-charge information based on an OV weight value will be described in detail with reference to FIG. 5.

The server 100 may store data on a processing period and a task satisfaction level according to a process, a task (step), and a person in charge for all tasks performed previously. In addition, the server 100 may divide information on standby, progress, completion, and person in charge for the currently generated and performed task into a first step to a last step and store the divided information and may calculate an OV value based thereon.

Annual average values of processing periods and task satisfaction levels for all tasks completed previously may be calculated, In this step, it is possible to check an average processing period and an average task satisfaction level for a corresponding task based on the task, not information on a specific person in charge (S541).

Thereafter, it is possible to calculate average values of processing periods and task satisfaction levels according to the type of tasks for the recent one month for each person in charge (S542).

That is, in order to check a processing period and a task satisfaction level of each person in charge, average values progressed for one month may be used.

It is possible to calculate deviations of the processing period and the task satisfaction level according to the type of task for each person in charge for a plurality of persons in charge (S543).

This is a step of calculating deviations so as to select a suitable person in charge with high proficiency for a corresponding task when a specific task is created.

Thereafter, the shorter the processing period for each task and the higher the task satisfaction level, the higher OV value may be calculated (S544).

In this case, tasks to be performed in each step of each task may be calculated, and thus, a different person in charge may be recommended and designated for each step for one process task.

The OV value may be calculated as a numerical value having a value of 0 to 100 according to a deviation of the average value by setting an average value to 50 for each type of task and each person in charge (S545).

In calculating the OV value, a weight value for the processing period and the task satisfaction level may be basically calculated at a ratio of 50:50, and when the weight value is changed by a user input, the OV value may be calculated according to a changed weight value.

In addition, in an additional embodiment of the present invention, when calculating the OV value, the OV value may be calculated by considering a current amount of task of each person in charge.

In a case in which the number of tasks currently assigned to a person in charge is more than a preset number, or in a case in which the task is not performed quickly by considering a task processing period of the person in charge, a value for the processing period may be set to be low even if the task processing period of the person in charge is short, and thereby, the OV value may be excluded from a list.

In addition, even if the OV value is included in a recommendation list, the value for the processing period may be calculated as a value obtained by adding a processing period of a currently ongoing task to a processing period for an actual task.

That is, the OV value may be determined differently according to a task load of each person in charge and may be calculated as a value lower than a value based on the past average value.

Referring to FIG. 5, an algorithm for calculating the OV value described above may be performed by deep learning.

That is, by performing deep learning of data on a task name, classification, task content, and a processing period and a task satisfaction level for each person in charge for the previously performed task, a specific task may be divided into numerical values for the processing period and the task satisfaction level, and a person in charge matched therewith may be recommended.

Even in the process performed by the deep learning, the OV value may be calculated and may be calculated by comparing with and analyzing past data.

Referring to FIG. 4, a selected input for any one of a plurality of pieces of person-in-charge information may be received from the user terminal 200, and detailed information of a selectively input person in charge may be provided to a window such as a new speech bubble, and in a case of being selected within a corresponding window, the selectively input person in charge may be selected as a final person in charge (S550).

In addition, in a case in which a plurality of persons in charge are required for the process, step S530 to step S550 may be repeated as many as the required number of persons in charge.

An embodiment of the present invention may also be implemented in the form of a recording medium including commands executable by a computer, such as a program module executed by a computer. A computer-readable medium may be any available medium that may be accessed by a computer and includes both a volatile medium and a nonvolatile medium, and both a removable medium and a non-removable medium, In addition, the computer-readable medium may include a computer storage medium. The computer storage medium includes both volatile and nonvolatile media and removable and non-removable media implemented in any method or technology for storage of information such as computer readable commands, data structures, program modules, or data.

Although the method and system according to the present disclosure are described with reference to specific embodiments, some or all of their components or operations may be implemented by using a computer system having a general purpose hardware architecture.

The above descriptions of the present disclosure are for illustration, and those skilled in the art to which the present disclosure pertains may understand that the embodiments may be easily modified into other specific forms without changing the technical idea or essential features of the present disclosure. Therefore, it should be understood that the embodiments described above are illustrative in all respects and not restrictive. For example, each component described as a single type may be implemented in a dispersed form, and likewise components described as distributed may be implemented in a combined form.

The scope of the present disclosure is indicated by following claims rather than the above detailed description, and all changes or modifications derived from the meaning and scope of the claims and their equivalents should be interpreted as being included in the scope of the present disclosure.

### REFERENCE SIGNS LIST

10: system

100: server 200: user terminal

300: user interface

310: processing time setting tab 320: task satisfaction level setting tab

330: department selection tab

400: person-in-charge recommendation graph

1. A person-in-charge recommendation system based on a task tracker which is performed by a server, comprising:
(a) receiving an input for generating a process task including information about a task to be requested from a user terminal owned by a task client;
(b) activating the task tracker corresponding to the process and receiving an input for the task tracker from the user terminal;
(c) providing a user interface for OV (optimal value) weight value input;
(d) providing a plurality of pieces of person-in-charge information to perform the process task, based on the OV weight value;
(e) receiving a selected input for any one of the plurality of pieces of person-in-charge information; and
(f) generating the process task such that a selected person in charge is included in the process task.

2. The person-in-charge recommendation system based on a task tracker which is performed by a server, according to claim 1, further comprising:
storing data on a task name, classification, task content, and a processing period and a task satisfaction level for each person in charge for a previously performed task, before the step (a).

3. The person-in-charge recommendation system based on a task tracker which is performed by a server, according to claim 2,
wherein the processing period is an average value of a period taken for a specific task for each person in charge, and
wherein the task satisfaction level is an evaluation score received from a user terminal requesting the process generation for each person in charge.

4. The person-in-charge recommendation system based on a task tracker which is performed by a server, according to claim 1,
wherein the step (a) further includes receiving an input for a task name, classification, and task content for the process generation.

5. The person-in-charge recommendation system based on a task tracker which is performed by a server, according to claim 1,
wherein the user interface of the step (c) receives weight value ratios for a task processing period and a task satisfaction level, performs adjustment within a numerical value in which a sum of the ratios for the task processing period and the task satisfaction level is 100, and applies a ratio value of “50” in a case of not receiving ratio values for the task processing period and the task satisfaction level from the user terminal,

6. The person-in-charge recommendation system based on a task tracker which is performed by a server, according to claim 5,
wherein the step (c) further includes receiving a selected input for any one department among a plurality of preset department lists.

7. The person-in-charge recommendation system based on a task tracker which is performed by a server, according to claim 1,
wherein the step (d) includes
calculating an annual average value of processing periods and task satisfaction levels of all tasks previously completed, and calculating an average value of processing periods and task satisfaction levels according to a type of task for recent one month of the plurality of persons in charge, and
calculating an OV value that is a deviation of a processing period and a task satisfaction level according to the type of task for each person in charge, wherein the shorter the processing period and the higher the task satisfaction level, the higher the OV value.

8. The person-in-charge recommendation system based on a task tracker which is performed by a server, according to claim 7,
wherein the OV value is calculated as a numerical value having a value of 0 to 100 according to a deviation of an average value by setting the average value as 50, for each type of task and for each person in charge.

9. The person-in-charge recommendation system based on a task tracker which is performed by a server, according to claim 1,
wherein the step (d) includes providing the plurality of pieces of person-in-charge information in a form of a two-dimensional graph, and
wherein the two-dimensional graph is a graph in which one axis is defined as a task processing period and the other axis is defined as a task satisfaction level.

10. The person-in-charge recommendation system based on a task tracker which is performed by a server, according to claim 9,
wherein, in step (c), in a case in which a selected input for any one department is received, information on all other users belonging to the department is provided as the person-in-charge information, and,
wherein, in step (c), in a case in which the selected input for the department is not received, information on a corresponding user among other pieces of user information previously stored is provided as the person-in-charge information, based on the OV weight value.

11. The person-in-charge recommendation system based on a task tracker which is performed by a server, according to claim 9,
wherein information on a person in charge with a highest matching rate based on the OV weight value among the plurality of persons in charge is provided in a color different from colors of other persons in charge.

12. The person-in-charge recommendation system based on a task tracker which is performed by a server, according to claim 1,
wherein, after the step (e), in a case in which a plurality of persons in charge are required for the process, the step (c) to the step (e) are repeated as many as the required number of persons in charge.

13. A server that operates a person-in-charge recommendation system based on a task tracker, comprising:
a memory storing a program a person-in-charge recommendation program based on the task tracker; and
a processor executing the program,
wherein the processor executes the program to
receive an input for process generation from a user terminal, activate the task tracker corresponding to the process and receive an input for the task tracker from the user terminal,
provide a user interface for OV (optimal value) weight value input,
provide a plurality of pieces of person-in-charge information based on the OV weight value, and
receive a selected input for any one of the plurality of pieces of person-in-charge information.
